(19) United States
(12) Patent Application Publication
(10) Pub. No.: US 2025/0192577 A1
(43) Pub. Date: Jun. 12, 2025

(54) LOCKER CABINET FOR STORING AND CHARGING RECHARGEABLE BATTERIES

(71) Applicant: MOBILE LOCKER NV, Wommelgem (BE)

(72) Inventors: Koen MORTELMANS, Zandhoven (BE); Jef VAN HYFTE, Brasschaat (BE); Thomas VAN HOOFSTADT, Antwerpen (BE)

(21) Appl. No.: 18/842,142

(22) PCT Filed: Feb. 27, 2023
(86) PCT No.: PCT/EP2023/054875

§ 371 Date: Aug. 28, 2024

(30) Foreign Application Priority Data
Feb. 28, 2022 (EP) 22159266.0

(51) Int. Cl. H02J 7/00; A62C 3/16

(52) U.S. Cl. CPC H02J 7/0029; A62C 3/16; H02J 7/0042

(57) ABSTRACT

A locker cabinet for storing and charging rechargeable batteries includes a plurality of compartments stacked on top of each other starting from a bottom compartment up to a top compartment. The locker cabinet has an aerosol generator located within an aerosol distribution chamber, and an aerosol controller is configured for activating the aerosol generator if a smoke alarm is triggered. The locker cabinet has a common chimney for evacuating gases from each of the plurality of compartments and each of the plurality of compartments comprises a gas evacuation opening fluidly connected with the common chimney. The back side of at least the bottom compartment comprises an opening fluidly connected with the aerosol distribution chamber such that when the first aerosol generator is activated the released aerosol flows from the aerosol distribution chamber into at least the bottom compartment through the opening in the back side of the bottom compartment.

### FIELD OF THE DISCLOSURE

The present disclosure relates to a locker cabinet for storing and charging rechargeable batteries.

### BACKGROUND

Locker cabinets for storing and charging rechargeable batteries are disclosed in for example U.S. Pat. No. 10,283,984B2. Such a locker cabinet typically comprises a plurality of compartments wherein each of the compartments is delimited by a first side wall, a second side wall opposite the first side wall, a bottom wall, a top wall opposite the bottom wall, an open front side and a back side opposite the open front side. Generally, each of the compartments comprises an power outlet for supplying power for charging a rechargeable battery when the rechargeable battery is stored in the compartment and a door is provided for securely closing off the open front side of the compartment.

The locker cabinet disclosed in U.S. Pat. No. 10,283,984B2 is a locker cabinet for charging devices such as for example tablet computers, laptops and mobile phones and such a locker cabinet is typical located inside a building, for example in a hotel, an airport or any other public location.

The known locker cabinets are however not suited for charging high capacity batteries such as Li-ion or Li-polymer batteries used for example for micro-mobility electrical devices such as E-bikes, E-steps or Hooverboards. It is known that these type of batteries can become unstable and initiate a fire. Generally when a fire occurs, fire suppression can be become very difficult due to for instance the occurrence of chemical reactions producing oxygen. When a fire in a battery initiates, temperatures can raise within seconds up to hundreds of degrees Celsius. Fire extinction is generally only possible by emerging the batteries in a bath of water for a long period of time.

In view of the danger involved when charging high-capacity batteries, some countries have forbidden to charge batteries of micro-mobility devices inside buildings such as for example hotels.

On the other hand, in view of the increasing number of micro-mobility electrical devices on the market, there is a need to provide for a safe and secure solution for charging batteries of these electrical devices.

### SUMMARY

It is an object of the present disclosure to provide for a safe, secure and cost-effective solution for charging batteries of for instance micro-mobility electrical devices. More precisely it is an object to provide a locker cabinet for outdoor charging and storing rechargeable batteries wherein the risk for fatal accidents involving raging fires or explosions is strongly reduced when compared to actual battery charging solutions.

According to the present disclosure, a locker cabinet for storing and charging rechargeable batteries is provided. The locker cabinet comprises a plurality of compartments stacked on top of each other starting from a bottom compartment up to a top compartment, and wherein each of the compartments is delimited by a first side wall, a second side wall opposite the first side wall, a bottom wall, a top wall opposite the bottom wall, an open front side and a back side opposite the open front side. Each of the plurality of compartments comprises a power outlet for supplying power for charging a rechargeable battery when stored in the compartment, and a door for closing off the open front side of the compartment.

The locker cabinet according to the present disclosure further comprises: an aerosol distribution chamber, a first aerosol generator located within the aerosol distribution chamber and configured such that when activated an aerosol is released into the aerosol distribution chamber, at least one smoke detector located within one of the plurality of compartments or located within the aerosol distribution chamber, an aerosol controller configured for activating the first aerosol generator if a smoke alarm is triggered by the at least one smoke detector, and a common chimney configured for evacuating gases from each of the plurality of compartments. Each of the plurality of compartments comprises a gas evacuation opening fluidly connected with the common chimney such that smoke or any other gas when present in any of the plurality of compartments can evacuate through the common chimney. Further, the back side of at least the bottom compartment comprises an opening fluidly connected with the aerosol distribution chamber such that when the first aerosol generator is activated the released aerosol flows from the aerosol distribution chamber into the bottom compartment through the opening of the back side of the bottom compartment.

Advantageously, with the locker cabinet according to the present disclosure when a fire occurs in any of the batteries stored in the locker cabinet, smoke and other gases generated inside a compartment can effectively be evacuated through the common chimney and fire can be suppressed with the aerosol being distributed to the compartments. This has a fire retardant effect and gives a fire brigade the time to come to the scene and to remove the batteries from the locker cabinet and transport them to a safe location and guarantee a complete fire extinction of the battery. The inventors have performed experiments with Li-ion and Li-polymer batteries and a locker cabinet according to the present disclosure. With these experiments it was demonstrated that a fire retardation of respectively 60 minutes and 30 minutes is obtained for high-capacity Li-ion and Li-polymer batteries, which gives sufficient time to alarm and have the fire brigade present on the scene.

Advantageously, as at least the back side of the bottom compartment comprises an opening in fluid connection with the aerosol distribution chamber, an aerosol entering the bottom compartment will push any smoke present upwards through the chimney and in addition, the aerosol will further be distributed through the chimney and the evacuation openings in the compartments such that eventually all the compartments are sprayed with aerosol. Experiments with a locker cabinet according to the present disclosure have demonstrated that all the compartments are sprayed with aerosol within 2 to 5 seconds after a fire alarm was triggered.

Advantageously as all compartments are fluidly connected with each other through the common chimney, it is not necessary to install a smoke detector in each of the compartments. The number of smoke detectors to be installed depends on the number of stacked compartments.

In embodiments, each of the compartments comprises a smoke detector. This increases the security of the locker cabinet, e.g. in case of failure of one of the smoke detectors.

In embodiments, an exit of the common chimney comprises a pressure relief valve configured for opening or closing the exit of the common chimney.

Advantageously, when the aerosol generator is activated following a smoke alarm, the aerosol is distributed in the locker cabinet and pressure is building up in the locker cabinet and the aerosol is pushing the smoke out of the locker cabinet through the chimney. Thereafter, when pressure is reduced again, the pressure relief valve is closing off the exit of the chimney such that no fresh air can enter the locker cabinet through the common chimney. In this way, a risk of a further outbreak of the fire is reduced.

The plurality of compartments of the locker cabinet according to the present disclosure are stacked on top of each other, i.e. they are stacked along an axis, e.g. a vertical axis.

The present disclosure is not limited to the number of stacked compartments, the number of stacked compartments is at least equal or larger than two, preferably equal or larger than three, more preferably equal or larger than four. The larger the number of compartments the more rechargeable batteries that can be stored and charged within a single locker cabinet.

In embodiments, in addition to the bottom compartment, other compartments of the plurality of compartments comprise a backside having an opening fluidly connected with the aerosol distribution chamber.

In embodiments, the back side of each of the plurality of compartments comprises an opening fluidly connected with the aerosol distribution chamber. Advantageously, this facilitates a fast and efficient distribution of the aerosol to all of the compartments.

In embodiments, the first aerosol generator comprises an aerosol outlet and the first aerosol generator is oriented such that when activated a flow of aerosol is released through the aerosol outlet in a direction towards, or at least partly towards, the backside of the bottom compartment. Advantageously, this facilitates an efficient aerosol distribution towards the backside of at least the bottom compartment.

In embodiments, the locker cabinet comprises a main controller coupled with the aerosol controller, and wherein the main controller is configured for sending out an alarm message to a fire department following a triggering of a smoke alarm with the at least one smoke detector. Advantageously, no time is lost for informing the fire department when a fire occurs in a battery stored in the locker cabinet.

### SHORT DESCRIPTION OF THE DRAWINGS

These and further aspects of the present disclosure will be explained in greater detail by way of example and with reference to the accompanying drawings in which:

FIG. 1a to FIG. 1i schematically illustrate various examples of cross-sectional side views of embodiments of locker cabinets according to the present disclosure,

FIG. 2 schematically illustrates a front view of an embodiment of a locker cabinet according to the present disclosure

FIG. 3a and FIG. 3b schematically illustrate a front cross-sectional view and a side cross-sectional view of a locker cabinet according to the present disclosure comprising nine compartments c1 to c9,

FIG. 4 schematically illustrates the control system of an embodiment of a locker cabinet according to present disclosure and the use of a second aerosol generator,

FIG. 5a and FIG. 5b schematically show respectively a cross-sectional front and side view of a locker cabinet according to the present disclosure illustrating interconnected locks of the compartments.

The drawings of the figures are neither drawn to scale nor proportioned. Generally, identical components are denoted by the same reference numerals in the figures.

### DETAILED DESCRIPTION OF EMBODIMENTS

The present disclosure will be described in terms of specific embodiments, which are illustrative of the disclosure and not to be construed as limiting. It will be appreciated by persons skilled in the art that the present disclosure is not limited by what has been particularly shown and/or described and that alternatives or modified embodiments could be developed in the light of the overall teaching of this disclosure. The drawings described are only schematic and are non-limiting.

Use of the verb “to comprise”, as well as the respective conjugations, does not exclude the presence of elements other than those stated. Use of the article “a”, “an” or “the” preceding an element does not exclude the presence of a plurality of such elements.

Furthermore, the terms first, second and the like in the description and in the claims, are used for distinguishing between similar elements and not necessarily for describing a sequence, either temporally, spatially, in ranking or in any other manner. It is to be understood that the terms so used are interchangeable under appropriate circumstances and that the embodiments of the disclosure described herein are capable of operation in other sequences than described or illustrated herein.

Reference throughout this specification to “one embodiment” or “an embodiment” means that a particular feature, structure or characteristic described in connection with the embodiments is included in one or more embodiment of the present disclosure. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one ordinary skill in the art from this disclosure, in one or more embodiments.

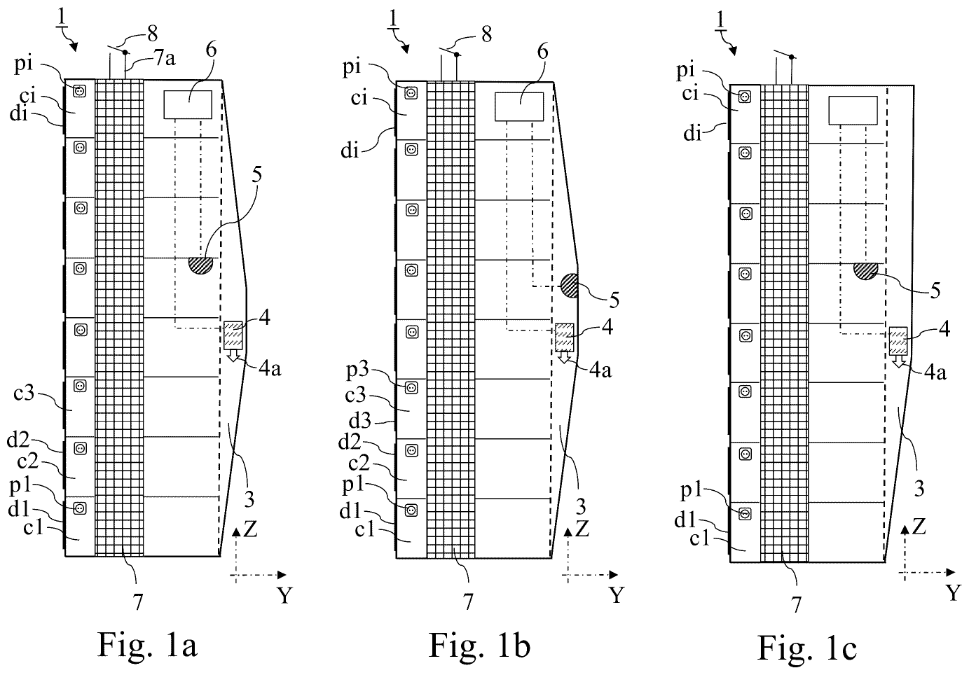

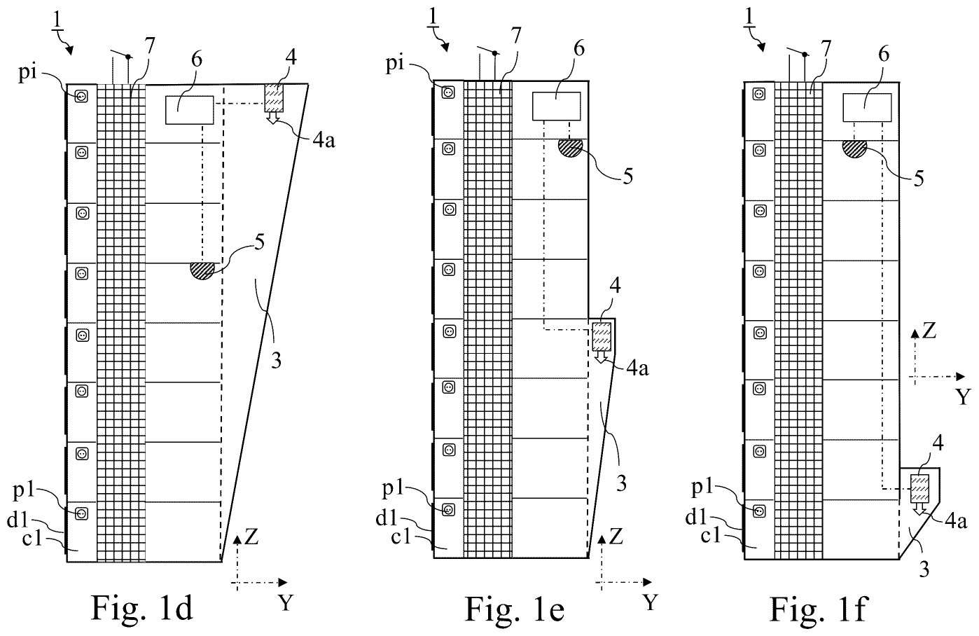

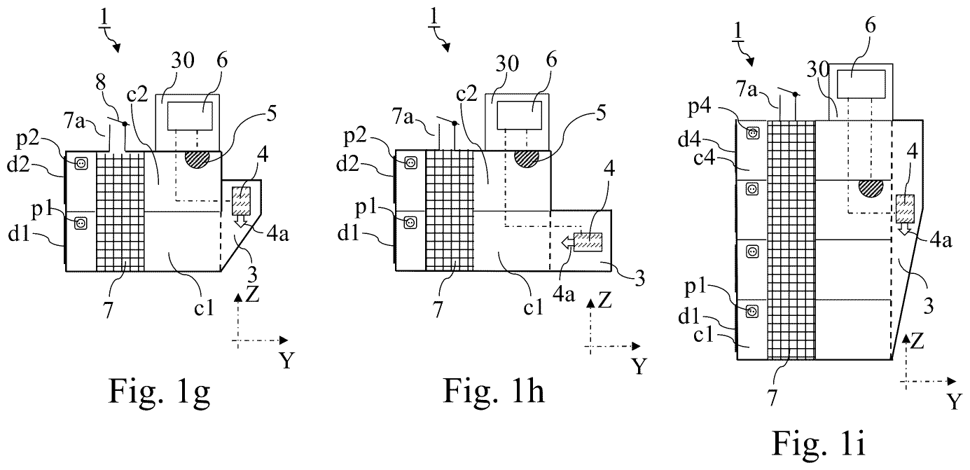

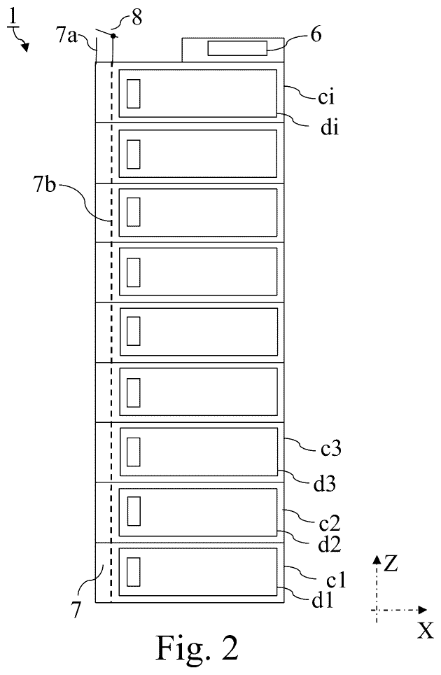

With reference to FIG. 1a to FIG. 3b, various views of examples of embodiments of locker cabinets 1 according to the present disclosure are shown. The locker cabinet 1 comprises a plurality of compartments c1,c2,c3,ci stacked on top of each other starting from a bottom compartment c1 up to a top compartment. Each of the compartments of a locker cabinet is delimited by a first side wall, a second side wall opposite the first side wall, a bottom wall, a top wall opposite the bottom wall, an open front side and a back side opposite the open front side.

The number of stacked compartments can vary from embodiment to embodiment but the number of stacked compartments is at least equal or larger than two, preferably equal or larger than three, more preferably equal or larger than four. In embodiments the number of stacked compartments is for example equal to nine.

Each of the plurality of compartments comprises a power outlet p1, p2, p3, pi for supplying power for charging a rechargeable battery when stored in the compartment and a door d1, d2, d3, di for closing off the open front side of the compartment.

In embodiments, each power outlet is configured to supply power up to 1000 Wh.

In embodiments, each of the compartments has a volume between 0.025 and 0.050 m³. In embodiments, each of the compartments is configured to receive a rechargeable battery having maximum dimensions up to 290×310×600 mm.

Hence, each of the compartments has to be construed as a separate cavity or chamber wherein for instance a rechargeable battery, e.g. a battery for an e-bike, can be stored and being recharged while stored.

In the embodiments shown on FIG. 1a to FIG. 3b, the compartments have a cuboid shape wherein the first and second side wall are parallel with a plane formed by axes Y and Z, and wherein the bottom side and upper side are parallel with a plane formed by axes X and Y, and wherein the front and back side are parallel with a plane formed by axes X and Z. The axis Z can also be named vertical axis.

In embodiments, the door of each of the compartments comprises an electronic lock that can be unlocked with for example a code. Typically, when a battery needs to be recharged, the user will unlock and open the door of a compartment, e.g. using the code of the lock, insert the rechargeable battery in the compartment and connect the rechargeable battery with the power outlet for charging the rechargeable battery, and finally close the door such that during charging of the rechargeable battery the compartment door is closed. In embodiments, when closing the door, the electronic lock of the door is automatically locking. In other embodiments, the user enters the code for locking the electronic door lock.

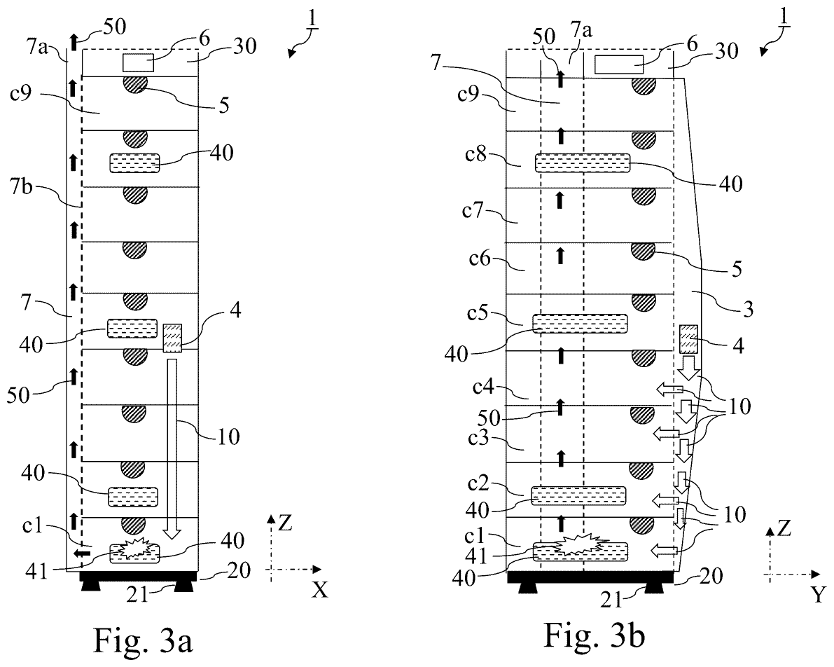

As illustrated for example on FIG. 1a to FIG. 1i and FIG. 3b, the locker cabinet according to the present disclosure comprises an aerosol distribution chamber 3 and a first aerosol generator 4 located within the aerosol distribution chamber 3. The aerosol generator 4 is configured such that when activated an aerosol is released into the aerosol distribution chamber 3. The aerosol generated with the first aerosol generator is to be construed as an aerosol suitable for fire suppression.

The back side of at least the bottom compartment c1 comprises an opening fluidly connected with the aerosol distribution chamber 3 such that when the first aerosol generator is activated the released aerosol flows from the aerosol distribution chamber 3 into the bottom compartment c1 through the opening of the back side of the bottom compartment.

The locker cabinet 1 further comprises at least one smoke detector 5 located within one of the plurality of compartments c1,c2,c3,ci or located within the aerosol distribution chamber 3, an aerosol controller 6 configured for activating the first aerosol generator 4 if a smoke alarm is triggered by the at least one smoke detector 5, and a common chimney 7 configured for evacuating gases from each of the plurality of compartments. The common chimney 7 is to be construed as a dedicated duct or channel for evacuating for instance smoke out of the locker cabinet. In FIG. 1a to FIG. 1i, the common chimney 7 is schematically illustrated with a squared pattern.

Each of the plurality of compartments c1,c2,c3,ci comprises a gas evacuation opening fluidly connected with the common chimney 7 such that smoke or any other gas when present in any of the plurality of compartments can evacuate through the common chimney 7.

Hence, the features of aerosol distribution chamber 3, first aerosol generator 4, at least one smoke detector 5, aerosol controller 6 and common chimney 7 are forming a fire suppression system for the locker cabinet 1.

Indeed, battery failures resulting in a fire are still a serious risk. Most common causes are related to charging, e.g. over-charging or bad charging, depletion, e.g. over depletion or too fast depletion or battery damage. Such a failure can trigger an internal thermal runaway followed by the ignition of surrounding materials and other nearby cells, escalating quickly. A battery fire typically starts with serious smoke generation. Hence with the at least one smoke detector 5 of the locker cabinet that is configured for triggering the aerosol generator 4 according to the present disclosure, an alarm is triggered as fast as possible and fire suppression starts quickly. For instance, with the locker cabinet according to the present disclosure one does not wait for heat dispersion before alarming and starting the fire suppression. With the fire suppression based on the smoke detection and the distribution of aerosols in the compartment of the cabinets, a fire retardant effect is obtained which gives a fire brigade the time to come to the scene and to remove the batteries from the locker cabinet and transport them to a safe location for guaranteeing a complete fire extinction of the battery.

In embodiments, as the common chimney fluidly interconnects each of the compartments, one smoke detector located in one of the compartments is sufficient to detect smoke resulting from a fire of a battery located in any of the compartments. This is for example schematically illustrated on FIG. 1a and FIG. 1c to FIG. 1i where one smoke detector 5 is installed in one of the compartments. In other embodiments, multiple smoke detectors can be installed.

In embodiments, as for example illustrated on FIG. 1b, one smoke detector can be installed in the aerosol distribution chamber 3. Also for this embodiment, when smoke is initiated in any of the compartments it will distribute to the other compartments through the common chimney 7 and further to the aerosol distribution chamber 3 via the opening in the backside of the at least bottom compartment c1.

In further embodiments a smoke detector 5 can be installed in each of the compartments of the locker cabinets, as for example schematically illustrated on FIG. 3a and FIG. 3b where a smoke detector 5 is installed in each of the nine compartments c1 to c9. Installing multiple smoke detectors increases the security, e.g. in case of failure of one of the smoke detectors, any smoke present in any of the compartments of the locker cabinet will be detected with a further smoke detector in another compartment as all compartments are fluidly connected through the common chimney.

In embodiments, as schematically illustrated for example on FIG. 1a to 1i, an exit 7a of the common chimney 7 comprises a pressure relief valve 8 configured for opening or closing the exit 7a of the common chimney 7. During normal operation of the locker cabinet, i.e. when no fire is present in any compartment, the pressure relief valve is closed.

In embodiments, the pressure relief valve 8 is configured for opening or closing the exit of the common chimney if a pressure inside the common chimney 7 is respectively above or below a threshold value.

In embodiments, the pressure relief valve 8 is configured for opening or closing the exit of the common chimney if a pressure difference between a pressure inside the common chimney 7 and a local outdoor atmospheric pressure is respectively above or below a threshold value.

For instance when aerosol is released, pressure is increasing and smoke or air in the cabinet is pushed out through the chimney and the pressure relief valve opens and air is evacuated out of the cabinet. As soon as the pressure drops, the pressure relief valve closes again. In this way the aerosol is maintained in the locker cabinet and no fresh air from the outside can enter the locker cabinet through the common chimney.

The locker cabinet is for example made out of multiple steel plates that are welded together in such a way that the locker cabinet is as much as possible air tight when all doors of the locker cabinet are closed. In this way, when a fire occurs, no fresh air from the outside can enter the locker cabinet or at least the air that could enter through small splits or crevices in the locker cabinet is strongly reduced. A locker cabinet manufactured with welded steel plates results in cost effective locker cabinet.

In embodiments, each door d1, d2, d3, di of the plurality of compartments comprises a seal for sealingly closing off the front side of the compartment when the doors of the locker cabinet are closed. The seal is for example a circumferential gasket.

As discussed above, at least the back side of the bottom compartment comprises an opening fluidly connected with the aerosol distribution chamber. In embodiments, this opening in the backside of the bottom compartment comprises a wire mesh. In this way, when inserting a rechargeable battery into the bottom compartment, the battery cannot further be pushed or accidentally enter into the aerosol distribution chamber.

In embodiments, the aerosol distribution chamber 3 is configured for distributing an aerosol towards multiple compartments. For example, for embodiments wherein the locker cabinet comprises more than three compartments, the aerosol distribution chamber 3 is configured for distributing an aerosol towards at least the back side of the bottom compartment and the back side of the compartment located on top of the bottom compartment. In these embodiments, at least the back side of the bottom compartment and the back side of the compartment located on top of the bottom compartment each comprise an opening fluidly connected with the aerosol distribution chamber 3.

In embodiments, as for example schematically illustrated on FIG. 1a to FIG. 1d and FIG. 3b the back side of each of the plurality of compartments c1,c2,c3,ci comprises an opening fluidly connected with the aerosol distribution chamber 3. For example, the back side of each compartment can be a fully open side in fluid connection with the aerosol distribution chamber.

In embodiments, wherein each of the compartments has a backside with an opening fluidly connected with the aerosol distribution chamber, each of the openings of the back side of the plurality of compartments comprises a wire mesh. As mentioned above, the wire mesh prohibits the user to push the battery too far inside the compartment such that it could fall inside the aerosol distribution chamber.

In embodiments a single wire mesh plate, e.g. made out of metal, extending from the bottom to the top of the locker cabinet is provided that is configured for covering each of the openings of the back side of the compartments of the locker cabinet.

With reference to FIG. 1e to FIG. 1h, examples of embodiments are shown wherein not all compartments have an opening in the backside that is fluidly connected with the aerosol distribution chamber 3. For example in the embodiment of FIG. 1e, having eight compartments, only the four lowest compartments have an opening in the back side that is fluidly connected with the aerosol distribution chamber. In these embodiments the compartments that do not have an opening in the backside will receive aerosols through the common chimney 7.

With reference to FIG. 1f, FIG. 1g and FIG. 1h an embodiment of a locker cabinet 1 is shown wherein only the backside of the bottom compartment c1 comprises an opening that is fluidly connected with the aerosol chamber 3.

The occurrence of a fire 41 in a rechargeable battery 40 located in a compartment of a locker cabinet according to the present disclosure is, as an example, schematically illustrated on FIG. 3a and FIG. 3b. In this example there is a rechargeable battery 40 stored in compartments c1, c2, c5 and c8, and a fire 41 is initiated in the rechargeable battery 40 located in the bottom compartment c1. The generated smoke 50 indicated with black arrows will enter the chimney 7 and escape from the locker cabinet through the chimney 7. As a result of a smoke detection with any of the smoke detectors 5, the aerosol generator 4 is activated and an aerosol flow 10, illustrated with white arrows, is released in the aerosol chamber 3 and flows towards the backside of at least the bottom compartment where it enters the bottom compartment through the opening in the back side.

An aerosol generator 4 for fire suppression is known in the art and is commercially available. An aerosol generator 4 is to be construed as any device that is suitable for generating an aerosol for suppressing a fire. In embodiments, the first aerosol generator 4 comprises at least one cannister filled with a solid compound, e.g. a potassium compound, that upon activation of the aerosol generator is transformed into an aerosol. The compound is generally also named FPC, Fire Protecting Compound. Commercial FPC cannisters exists in different sizes and they are generally specified by the weight of the compound in the cannister, for example cannisters filled with 100 gram or 200 gram of FPC compounds. An aerosol is hereby defined as a 2-phased media consisting of solid particles suspended in a gas. In embodiments according to the present disclosure, the first aerosol generator comprises one cannister, for example a cannister of 100 gram or a cannister of 200 gram FPC compound. In other embodiments, the first aerosol generator comprises multiple cannisters, for example two cannisters of 100 gram FPC compound, or two cannisters of 200 gram compound.

The aerosol generator typically comprises an electrical actuator to initiate the transformation of the solid compound into an aerosol and to release the aerosol out of the aerosol generator. In embodiments, the activation of the electrical actuator of the aerosol generator is controlled by the aerosol controller 6. In embodiments wherein the first aerosol generator comprises multiple cannisters of FPC compound, for example two cannisters, then following a smoke alarm, each of the cannisters of the first aerosol generator are activated at the same time.

The aerosol generator 4 typically comprises an aerosol outlet 4a, as schematically shown on FIG. 1a to FIG. 1i. In embodiments, the first aerosol generator 4 is oriented such that when the first aerosol generator 4 is activated a flow of aerosol is released through the aerosol outlet 4a in a direction towards, or at least partly towards, the backside of the bottom compartment c1. In this way, following activation of the aerosol generator, a flow of aerosol is guided to the backside of the bottom compartment and enters the bottom compartment c1 through the opening in the backside of the bottom compartment. For example, on FIG. 1a to FIG. 1i, the aerosol outlet 4a is schematically illustrated with an arrow wherein the direction of the arrow indicates a direction of the aerosol flow when exiting the aerosol outlet 4a.

In embodiments wherein the backside of multiple compartments is fluidly connected with the aerosol distribution chamber, when the aerosol generator is activated the aerosol will flow to the backside of multiple compartments and hence enter multiple compartments. This is schematically illustrated on FIG. 3b where each of the compartments has an opening in the backside and wherein the outlet of the aerosol generator is pointing downwards towards the bottom compartment. The white arrows on FIG. 3b indicate a flow 10 of aerosols after activation of the aerosol generator. In this embodiment, the aerosol will mainly enter the backside of compartments c1, c2, c3 and c4. The other compartments, c5 to c9, on top of compartment c4 will receive aerosols through for instance the common chimney 7 and the gas evacuation opening in the compartments that are fluidly connected with the common chimney 7.

As discussed above, each of the plurality of compartments c1,c2,c3,ci of the locker cabinet comprises a gas evacuation opening fluidly connected with the common chimney 7. In embodiments, for each of the plurality of compartments the gas evacuation opening to the chimney comprises a wire mesh. In this way it is avoided that an object stored in the locker would fall in the common chimney.

In embodiments, as for example schematically illustrated on FIG. 3a, a wire mesh plate, indicated with reference 7b, is extending form the bottom compartment to the upper compartment and is configured for covering each of the gas evacuation openings of the compartments.

For providing a common chimney for the plurality of compartments of the locker cabinet, different mechanical solutions can be envisioned by the person skilled in the art. In embodiments, the common chimney 7 is coupled to each of the first side walls of the plurality of compartments and wherein for each of the compartments the gas evacuation opening corresponds to a wall opening through the first side wall giving access to the common chimney. For these embodiments, the common chimney 7 can also be named side duct.

In embodiments, the common chimney can have a rectangular cross-section. For instance a cross-section of the common chimney with a plane parallel with the plane X-Y shown on FIG. 1a to FIG. 3b, has a rectangular shape. In other embodiments, the chimney can have any other suitable cross-section.

In embodiments, as illustrated for example on FIG. 1a to FIG. 3b, the plurality of compartments are stacked along a vertical axis Z and the common chimney 7 is elongating parallel with the vertical axis Z from a bottom side of the chimney to an upper side of the common chimney.

In embodiments, when the locker cabinet is positioned in an operational position, the vertical axis Z is parallel with an axis of gravitation.

In embodiments, as illustrated on FIG. 3a and FIG. 3b, the locker cabinet comprises 1 a base 20 supporting the stacked compartments. In embodiments, the base 20 comprises a plurality of feet 21, for example four feet to facilitate the positioning of the locker cabinet 1 on a floor.

In embodiments, the aerosol distribution chamber 3 is elongating parallel with the vertical axis Z and is forming a back side of the locker cabinet 1. In these embodiments, the aerosol distribution chamber could also be named rear duct.

In embodiments a cross-section of the aerosol chamber 3 with a plane perpendicular to the vertical axis Z has a rectangular shape.

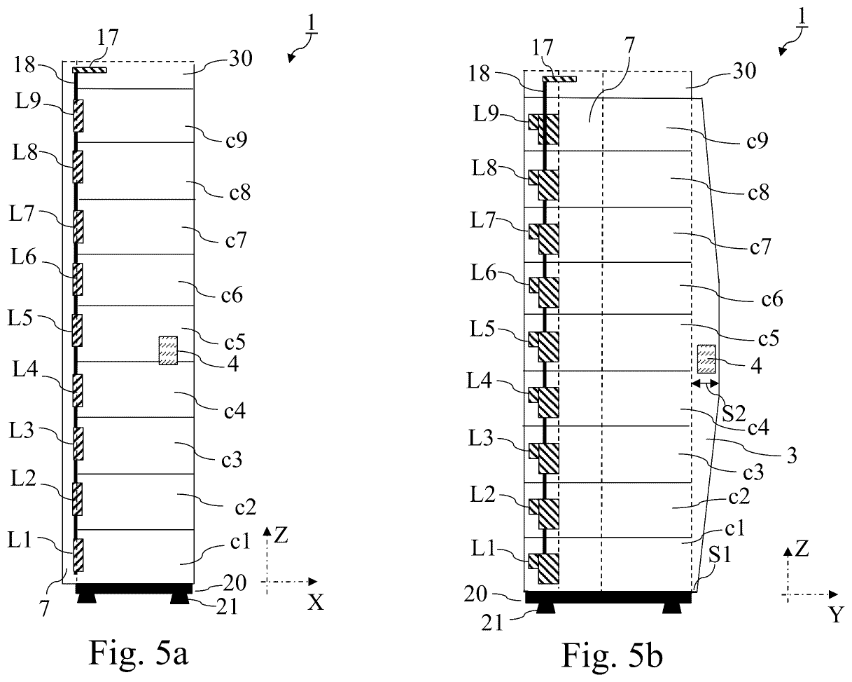

In embodiments, as illustrated on FIG. 5b, a first cross-section S1 of the distribution chamber 3 with a plane perpendicular to the vertical axis Z measured at the lower end of the aerosol distribution chamber 3 is smaller than a second cross-section S2 of the distribution chamber 3 with a plane perpendicular to the vertical axis Z measured at a location of the first aerosol generator 4.

In embodiments, the cross-section of the aerosol distribution chamber with a plane perpendicular to the vertical axis Z is increasing when moving along the vertical axis Z from the lower end of the aerosol distribution chamber towards the location of the first aerosol generator 4. In embodiments this increasing of the cross-section is a linear increase.

The variation of the cross-section of the aerosol distribution chamber guides the aerosols and improves the efficient distribution of aerosol to a plurality of compartments such that each of the plurality of compartments receives a similar amount of aerosol.

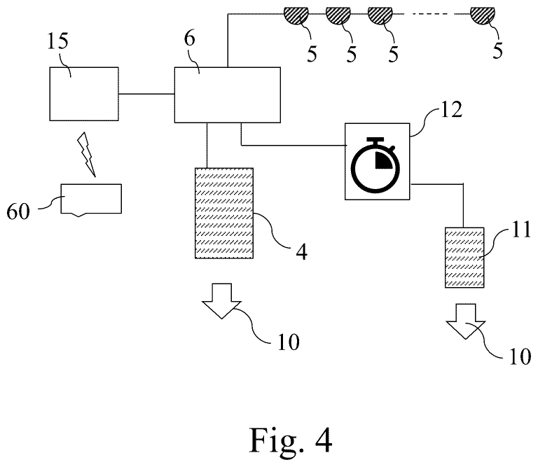

In embodiments, the locker cabinet comprises a second aerosol generator 11 located within the aerosol distribution chamber 3 and configured such that when activated a further aerosol is released into the aerosol distribution chamber 3 after a given predefined time delay time has elapsed since the activation of the first aerosol generator 4. This is schematically illustrated in FIG. 4, wherein for example a delay relay 12 between an activation output of the aerosol controller 6 and the second aerosol generator 11 is installed. For example, the delay relay 12 can be set to a value for example between ten and thirty minutes. Typically, the first aerosol generator has a capacity to release a flow of aerosol during 5 to 10 seconds. The second aerosol generator releasing a second flow of aerosol, can be construed as a safety backup generator for the situation wherein for example small air leaks would potentially re-ignition the fire. With the second aerosol generator it is guaranteed that the fire department can be present at the scene in due time before a raging fire would occur.

In embodiments, the second aerosol generator, as is the case for embodiments of the first aerosol generator, comprises at least one cannister filled with an FPC compound. In embodiments, the second aerosol generator comprises one cannister filled with an FPC compound, in other embodiments the second aerosol generator comprises multiple cannisters filled with an FPC compound, for example two cannisters.

In embodiments, the first aerosol generator comprises one cannister of 200 gram FPC compound and the second aerosol generator comprises one cannister of 100 gram FPC. In other embodiments, the first aerosol generator comprises one cannister of 200 gram FPC compound and the second aerosol generator comprises also one cannister of 200 gram FPC.

In embodiments, the second aerosol generator 11 is installed at a same height along the vertical axis Z as the first aerosol generator 4 and the first and second aerosol generator are separated by a given distance measured along the X axis.

In embodiments, the second aerosol generator is oriented such that when activated aerosol of the second aerosol generator flows in the same direction as aerosol generated by the first aerosol generator.

In embodiments, as further illustrated on FIG. 4, the locker cabinet can further comprise a main controller 15 coupled with the aerosol controller 6. The main controller 15 can also be named locker controller and is configured for sending out an alarm message 60, for instance to a fire department. In embodiments, this alarm message can be send out via a phone. In embodiments, the alarm message is a text message transmitted by phone or by e-mail. In embodiments, the main controller 15 sends out the alarm message 60 when receiving an alarm or error signal from the aerosol controller 6. This aerosol controller 6 generates this alarm or error signal as soon as one of the smoke detectors 5 has triggered a smoke alarm.

In embodiments, the aerosol controller 6 is installed on top of the locker cabinets, e.g. on the roof of the locker cabinet. In embodiments, as illustrated on FIG. 3a and FIG. 3b, the locker cabinet comprises a dedicated technical compartment 30, for example on top of the upper compartment c9, that comprises the aerosol controller 6. In other embodiments, as illustrated on FIG. 1a to FIG. 1f, the aerosol controller is located in the upper compartment, in which case the upper compartment is permanently locked and not used for charging a rechargeable battery.

With reference to FIG. 5a and FIG. 5b, cross-sectional views respectively in a plane X-Z and a plane Y-Z are schematically shown of an example of a locker cabinet according to the present disclosure wherein each compartment, in this example nine compartments c1 to c9, comprises a corresponding door lock L1 to L9. Each door lock L1 to L9 comprises an emergency release lever to unlock the door of the compartment, i.e. without making use of a door code, and the locker cabinet comprises a lock interconnector 18 that is interconnecting each of the emergency release levers towards a main release lever 17 located in the upper compartment or located in the technical compartment 30 on top of the upper compartment c9. The emergency release levers of each door lock, the lock interconnector 18 and the main release lever 17 are configured such that when activating the main release lever 17, all doors of the compartments will pop open.

If the main release lever 17 is located in the upper compartment, this compartment will be locked at all time and will be opened by the personnel of the fire department in case of a fire.

Typically, when the fire response team arrives on the scene following a fire alarm of the locker cabinet, the fire response team will perform the following actions: open all the lockers using the emergency release lever, cool the batteries with CO₂ fire extinguishers, remove damaged batteries from the locker cabinet, submerge batteries having taken fire in a metal container filled with water.

The inventors have performed experiments with Li-ion and Li-polymer batteries and a locker cabinet according to the present disclosure to demonstrated that a fire suppression can effectively be performed when a battery fire occurs in any of the batteries stored in the locker cabinet. With the experiments it was demonstrated that a fire retardation of respectively 60 minutes and 30 minutes is obtained for high-capacity Li-ion and Li-polymer batteries, which gives sufficient time to alarm and have the fire brigade present in due time on the scene.

The present disclosure is also related to a battery charging system comprising a plurality of locker cabinets positioned adjacently to each other. Indeed, the locker cabinet according to the present disclosure can be construed as a locker cabinet module and by placing multiple modules adjacently together a larger battery charging system is formed. These battery charging systems can for example be installed outdoor near an apartment building or public building.

1.-15. (canceled)

16. A locker cabinet for storing and charging rechargeable batteries, the locker cabinet comprising a plurality of compartments stacked on top of each other starting from a bottom compartment up to a top compartment, and
wherein each of the compartments is delimited by a first side wall, a second side wall opposite the first side wall, a bottom wall, a top wall opposite the bottom wall, an open front side and a back side opposite the open front side, and
wherein each of the plurality of compartments comprises:
a power outlet for supplying power for charging a rechargeable battery when stored in the compartment, and
a door for closing off the open front side of the compartment,
wherein the locker cabinet further comprises:
an aerosol distribution chamber,
a first aerosol generator located within said aerosol distribution chamber and configured such that when activated an aerosol is released into the aerosol distribution chamber,
at least one smoke detector located within one of said plurality of compartments or located within the aerosol distribution chamber,
an aerosol controller configured for activating the first aerosol generator if a smoke alarm is triggered by the at least one smoke detector,
a common chimney configured for evacuating gases from each of the plurality of compartments, and
wherein each of the plurality of compartments comprises a gas evacuation opening fluidly connected with said common chimney such that smoke or any other gas when present in any of the plurality of compartments can evacuate through the common chimney, and
wherein the back side of at least the bottom compartment comprises an opening fluidly connected with the aerosol distribution chamber such that when the first aerosol generator is activated the released aerosol flows from the aerosol distribution chamber into the bottom compartment through said opening of the back side of the bottom compartment.

17. The locker cabinet according to claim 16, wherein an exit of said common chimney comprises a pressure relief valve configured for opening or closing the exit of the common chimney.

18. The locker cabinet according to claim 17, wherein said pressure relief valve is configured for opening or closing the exit of the common chimney if a pressure inside the common chimney is respectively above or below a threshold value or
wherein said pressure relief valve is configured for opening or closing the exit of the common chimney if a pressure difference between a pressure inside the common chimney and a local outdoor atmospheric pressure is respectively above or below a threshold value.

19. The locker cabinet according to claim 16, wherein each door of said plurality of compartments comprises a seal for sealingly closing off the front side of the compartment.

20. The locker cabinet according to claim 16, wherein the opening in the backside of the bottom compartment comprises a wire mesh.

21. The locker cabinet according to claim 16, comprising more than three compartments and
wherein the aerosol distribution chamber is configured for distributing an aerosol towards at least the back side of the bottom compartment and the back side of the compartment located on top of the bottom compartment, and
wherein at least the back side of the bottom compartment and the back side of the compartment located on top of the bottom compartment each comprise an opening fluidly connected with the aerosol distribution chamber.

22. The locker cabinet according to claim 16, wherein the back side of each of the plurality of compartments comprises an opening fluidly connected with the aerosol distribution chamber.

23. The locker cabinet according to claim 22, wherein each of the openings of the back side of the plurality of compartments comprises a wire mesh.

24. The locker cabinet according to claim 16, wherein for each of the plurality of compartments the gas evacuation opening comprises a wire mesh.

25. The locker cabinet according to claim 16, wherein said first aerosol generator comprises an aerosol outlet, and
wherein the first aerosol generator is oriented such that when activated a flow of aerosol is released through the aerosol outlet in a direction towards or at least partly towards the backside of the bottom compartment.

26. The locker cabinet according to claim 16, wherein the common chimney is coupled to each of the first side walls of the plurality of compartments and wherein for each of the compartments said gas evacuation opening corresponds to a wall opening through said first side wall giving access to the common chimney.

27. The locker cabinet according to claim 16, wherein said plurality of compartments are stacked along a vertical axis, said common chimney is elongating parallel with the vertical axis from a bottom side of the common chimney to an upper side of the common chimney.

28. The locker cabinet of claim 27, wherein said aerosol distribution chamber is elongating parallel with said vertical axis from a lower end to an upper end of the aerosol distribution chamber, and
wherein a first cross-section of the distribution chamber with a plane perpendicular to said vertical axis measured at said lower end of the aerosol distribution chamber is smaller than a second cross-section of the distribution chamber with a plane perpendicular to said vertical axis measured at a location of the aerosol generator, the cross-section of the aerosol distribution chamber with a plane perpendicular to the vertical axis is increasing when moving along the vertical axis from the lower end of the aerosol distribution chamber towards the location of the first aerosol generator.

29. The locker cabinet according to claim 16, comprising a second aerosol generator located within said aerosol distribution chamber and configured such that when activated a further aerosol is released into the aerosol distribution chamber after a given predefined time delay has elapsed since the activation of the first aerosol generator, the locker cabinet comprises a delay relay configured for defining said predefined time delay.

30. The locker cabinet according to claim 16, further comprising a main controller coupled with the aerosol controller, and
wherein the main controller is configured for sending out an alarm message to a fire department following a triggering of a smoke alarm with the at least one smoke detector.
